(19) United States
(12) Patent Application Publication
(10) Pub. No.: US 2014/0340895 A1
(43) Pub. Date: Nov. 20, 2014

(54) Light with Reflector or Diffuser Screen

(71) Applicant: Jürgen NÖLLE, Rheinberg (DE)

(72) Inventor: Jürgen Nölle, Rheinberg (DE)

(21) Appl. No.: 14/359,303

(22) PCT Filed: Nov. 19, 2012
(86) PCT No.: PCT/DE2012/001096

§ 371 Date: May 20, 2014

(30) Foreign Application Priority Data
Nov. 22, 2011 (DE) 102011119042.6

(51) Int. Cl. F21V 14/08; F21V 14/04; F21V 15/01

(52) U.S. Cl. CPC F21V 14/08; F21V 15/01; F21V 14/04
USPC 362/235

(57) ABSTRACT

The invention relates to a light (1) comprising a housing (2) with at least one illuminant (8) and an illuminant holder (9). In order to enable a targeted light emission and hence illumination of a particular region, the housing (2) has a translucent housing element (3), which can be covered at least partially by at least one moveable screen (4, 5) and thus limits the emission angle.

### CROSS REFERENCE TO RELATED APPLICATIONS

This application is the U.S. national stage of International Application No. PCT/DE2012/001096 filed on Nov. 19, 2012, and claims the benefit thereof. The international application claims the benefit of German Application DE 102011119042.6 filed on Nov. 22, 2011; all applications are incorporated by reference herein in their entirety.

### BACKGROUND

The invention relates to a light comprising a housing with at least one illuminant and an illuminant holder.

Lights are required for a variety of purposes. As an example, lights are used in automotive workshops to light up part of the engine compartment so that the work environment can be adequately illuminated. Lights of that type consist of a round hand-held light with a short design containing a number of illuminants, for instance. Furthermore, lights for illuminating public traffic areas are known, which usually consist of a housing mounted on a pole with a light opening. Lights of that type are arranged in fixed locations in the area of a pedestrian zone or along a road as a preference.

In addition, a multitude of lights exist that are used to light up construction or accident sites. Lights that are roughly round are preferably used for this purpose; they have a balloon cover filled with gas or a screen held in a ready-to-operate position with the aid of clamping devices. The advantage of this design is that the screen can be folded up after use by releasing the tension in the clamping devices, similar to an umbrella, and substantially simplified transport possibilities consequently exist. In contrast, balloon lights are filled with an inert gas and no possibility exists to reuse the inert gas. This means that the balloon covers are used in the blow-up form over a fairly long period of time as a rule, and they can therefore only be transported under certain circumstances.

It turned out that a disadvantage of the two lights mentioned above was that all-round lighting over a lit-up field of 360° is not necessary in all cases. Radiation downwards and upwards cannot be avoided in the specific case of balloon lights, whereas, in contrast, the upper area of the screen can be designed to be a reflector in the case of the opened screen lights while the lower area is designed to be translucent; this will consequently bring about light diffusion that prevents a blinding effect to a very great extent. There will be a natural limit to the application in so far as lights of that type are to be used to illuminate certain narrowly defined boundaries.

### DETAILED DESCRIPTION

The present invention is based on the problem of providing a new type of light that avoids the drawbacks of the prior art and that makes targeted illumination of a specific subsection of an area possible.

The invention envisages that the housing of the light has a light-transmitting housing element that can at least partially be covered by a movable screen. Further advantageous design forms of the invention follow from the subordinate claims.

If a light is comprised of a housing with a housing element that is at least partially translucent, the light radiated by the illuminant can be limited to a specified area. The possibility exists to influence the area that is illuminated because of the use of a movable screen that at least partially covers the light-transmitting housing element. The area to be illuminated can consequently be restricted with the aid of the movable screen; the versatility of a light of that type can be substantially increased because of that. The screen itself can be made of a translucent material to obtain a diffused light effect, for instance. The possibility likewise exists for the screen to be designed in part as a reflector so that the light radiated from the illuminants is partially reflected and can only be emitted from the area of the light-transmitting housing element that is approved by the user via the reversibly adjustable screen.

The light as per the invention distinguishes itself as far as this is concerned by the fact that it can be converted without much effort via two pull-out roller blinds, for instance, from an all-round light over 360 degrees without any influence on the light effect to an all-round diffuser light over a range of 360 degrees by pulling out a diffuser blind. A reduced blinding effect similar to that of a diffused balloon lamp can be obtained with the aid of the diffuser here. If a diffuser is not used and an opaque reflector screen is used, for instance in the form of a roller blind, the vertical radiation angle can be adjusted on a step-by-step basis so that a floodlight arises with a directional light field. The light as per the invention consequently has several functions that can be optionally selected by the user in conformity with the intended use in each case. The special advantage here is that the user does not have to take along several different types of lights or keep them available, but can instead freely choose to select an all-round light, a floodlight or a diffuser light in accordance with the required lighting situation. Thus, a three-in-one concept is involved, meaning three different illumination concepts that can be fulfilled with a single light.

A housing element is provided here that has one or more openings from which light can shine for the light to be emitted. Alternatively, there is a possibility for the housing element to be comprised of one or more transparent housing sections from which light can be emitted; it is simultaneously ensured via the use of at least one screen that the emission of the light will only bring about illumination in a desired area.

A preferred design form envisages that the housing has at least upper and lower housing parts that are connected to one another by a light-transmitting housing element and that at least one screen is arranged between two housing elements. The screen serves the purpose of at least partially covering the existing, light-transmitting housing element in the form of a reflector screen or, in the case of a translucent screen design, bringing about light scattering in order to influence the light radiation.

The possibility exists with a combination of a translucent screen and a reflector screen to not only illuminate a narrowly defined area but, on top of that, to also achieve a sufficiently optimal scattering effect to rule out a blinding effect.

The light as per the invention in the form of a halogen light or a HQI light (halogen quartz iodide lamp) is normally equipped with the corresponding illuminants. A special design form of the light envisages that the upper and lower housing parts have a central through-hole. This through-hole serves to cool the light, creating an air flow that can flow from the bottom, through the entire light and out of the upper housing part. The possibility exists here to equip an inner hollow cylinder with LEDs in the form of an LED light tube; this hollow cylinder is mounted inside of the light in correspondence with the through-hole of the two housing parts. The air required to cool the LEDs can consequently flow through the hollow cylinder and the upper and lower through-holes of the housing parts and provide for adequate cooling of the LED light tube. The LEDs are fastened to the outside of the inner hollow cylinder in this case, whereas the cooling tube for support can be equipped on the inside with cooling ribs that make an additional contribution to the cooling based on the air flow. The inner cooling tube can be manufactured completely separately from the luminous element with this solution. An assembly arises made up of an LED light tube that is equipped on the outside with LEDs. The hollow cylinder used here as a tube element, made of a metal tube for instance, is hermetically sealed vis-a-vis the LEDs so that a good seal against moisture and water can be achieved. The interior of the hollow cylinder can, in contrast, unconditionally come into contact with a wet and moist environment and it only serves to bring about the necessary cooling, whereas the electrical components, LEDs and wiring are arranged on the outside of the hollow cylinder in the interior of the light with protection against moisture. The hollow cylinder with LEDs and wiring is, moreover, shielded by the housing element in a protective way; it could be comprised of a protective glass bulb or translucent polymer plastic, for example, so that the entire interior of the light as per the invention is sealed up airtight. The LED light tube is installed in the light in such a way that the hollow cylinder is in alignment with the through-holes of the two housing parts and the air can consequently flow through without hindrance. The possibility exists here to additionally arrange at least one fan that brings about greater air flow, as an example, in the opening of the hollow cylinder. The fan can be controlled in connection with this in such a way that it continually runs or, if applicable, is only switched on when a temperature limit is exceeded, so that the normal cooling via the air flow can preferably be exploited.

Furthermore, the design of a special embodiment envisages that the housing element is comprised of a cylindrical glass or plastic cover, which is seated directly or via a guide element attached to it in an annular groove or a corresponding guide element of the housing parts. This embodiment is comprised here of a lower housing part and an upper housing part, between which the light-transmitting housing element is located. As an example, this could involve another transparent, hollow cylinder made of glass or a translucent plastic material, the ends of which are inserted in available annular grooves of the housing parts and/or are connected to the housing parts. If necessary, the end faces of the transparent housing element can be equipped with a reinforcing ring or transition into a metal ring that makes a direct connection to the housing parts possible; as an example, the housing parts could be screwed to the metal ring.

In the transparent housing element, there is at least one illuminant that is either inserted into a holding base and capable of having an electrical voltage applied or, in the case of the use of an LED light tube, centrally seated between the two housing parts and therefore likewise arranged behind the transparent housing element.

Another design form of the invention envisages that at least one screen is arranged between the two housing parts in the axial direction or in the direction of the circumference so as to be capable of reversible motion, in particular capable of being pulled out or rolled out. In the first case, a screen could be involved that can be moved in the direction of the circumference of the transparent housing element, meaning along the circumference; the height of the screen is adapted to the axial extension of the transparent housing element. Alternatively, there is a possibility for a tube-shaped screen to be pulled down in the axial direction of the light, preferably from the upper housing part, so that light can only escape from a section of the transparent housing element. The outlet window can consequently be reduced by a screen that is capable of moving from the top to the bottom. The outlet angle can be influenced with the aid of the screen capable of moving around the circumference in the above-mentioned embodiment, on the other hand, so light can only radiate over a range of 45°, 90° or 180°, even over 270° if necessary; in an extreme case, depending on the intended use, radiation over nearly 360° is naturally also possible. The light as per the invention is consequently very suitable for filming and for illuminating construction sites or accident sites, because a spatial section can be selected as desired for illumination via the reflector.

The possibility exists here without further ado to use two screens that are attached in the direction of the circumference and capable of reversible movement or at least one screen that can move in the axial direction, so a combination of different screens is possible. The screens themselves can be designed to be translucent or reflecting depending on the intended use, so the light-transmitting opening of the light can be covered by the translucent screen, for instance, whereas the light outlet opening can be restricted with the reflecting screen. The two or possibly more screens can preferably be designed in such a way that they slide over one another and can be moved with a spacing vis-a-vis one another, so that there is no dependency in the movement of the individual screens.

If two screens are provided, one screen can be arranged behind the transparent housing element and another screen can be arranged in front of the housing element so as to improve the mobility of the two screens.

A special design form of the invention envisages that a radially interior screen is designed as a diffuser in the light and a radially exterior screen is designed as a reflector; it has a reflector layer on the side turned towards the illuminant. The inner screen as the diffuser brings about a translucent scattering of light, so freedom from blinding glare can be ensured, whereas the radially exterior screen with the reflector layer makes a bundling of the light possible in the direction of the outlet.

A further design form envisages that the reflector can be comprised of a textile material that is designed to transmit light and that has highly reflecting foil or mirror foil on the inside facing towards the illuminant. A design form of the reflector of that type consequently makes a reflection of the outgoing light possible in the desired direction; the reflector can be latched in several latching steps distributed over the circumference of the light, so a radiation angle of 360 degrees, 270 degrees or 180 degrees can be set, for example.

If floodlight radiation is to be avoided because of the blinding effect, a diffuser can be used instead that is comprised of a light-transmitting material, preferably a textile material, or a translucent foil, for instance PVC foil. Both of the materials can be rolled up in the form of a roller blind, so this diffuser foil can also be latched in various positions over the circumference of the light if that is desired. Latching is preferably done after the diffuser has been pulled over 360 degrees of the circumference of the light so that it emits diffuse light without much of a blinding effect over the entire angle of radiation. If one of the two screens is arranged between the illuminant and the transparent housing element and the inner screen is therefore behind the housing element, whereas the outer screen is arranged outside of the housing element, damage to the screens because of mutual friction when they are adjusted can be ruled out. Furthermore, it is conceivable for both screens to also be arranged behind the housing element and for a corresponding, spaced guide to be provided for both screens with an adjustment possibility in the upper and lower housing parts.

Another design form of the invention envisages that at least one, preferably every, screen has a handgrip or finger eyelet to ensure that there is a simple possibility for adjustment and, moreover, to rule out a situation in which the screens can get dirty when they are touched.

The housing and/or the screens can have latching means to hold the screens; they are correspondingly designed for one another and make it possible to fixed the screens in place in any desired position or in latching steps. If the screens have to be pulled over the circumference of a light or its housing as the case may be, an unrolling mechanism of the screens can be used here; the extractable end of the screen can be equipped with latching means comprised of a rod, for instance, that can in turn be hung up in a corresponding way in existing projections or latching positions of the housing parts. The number of latching means determines the possibilities for adjustment and therefore the size of the gap for the emitted light.

A special design form of the invention envisages that at least one, preferably two, corresponding housing parts have at least one holder for seating at least one screen; the holder is designed in the form of a lateral projection. A projection of that type can be created in one piece with the upper and lower housing parts; the projection for the seating of the screen is provided in such a way that an unrolling function is ensured. The possibility exists here without further ado to provide a projection of that type to seat at least two screens that can be fixed in place over the circumference of the housing parts by unrolling them in the same direction or in the opposite direction. The screens can be mounted here so as to be capable of being rotated and rolled up in the holder that is used, similar to a roller blind, and they can consequently be pulled out of the holder like a blind and engage with the existing projections or latching positions of the housing parts via the handgrips and the latching means that are provided so that it is possible to firmly fix the screens in place over the circumference. The two screens can be designed to roll out and roll up, similar to well known roller blinds in the living room, to simplify return movement, for instance. To this end, tension can be put on either a spring or an elastic rubber element when the screens are pulled out so that a rewinding of the screen is made possible with the aid of the spring or the elastic elements.

In the simplest form, the light is provided with a holder in which the screens are supported so as to be capable of rotating and being rolled up. As far as that is concerned, the screens can be pulled out of the holder like roller blinds and fixed in place along the circumference of the light. A further special design form envisages that at least one, preferably two, screens can be moved through a gearing stage in each case via a Bowden cable, a pull chain or a pull rope. If a gearing stage is provided, it can be operated by hand with a manually actuated knob that directly acts on the adjustment mechanism of the screens via the gearing stage. A spindle with an upper and/or lower gear ring that meshes with the gearing of a ring element is a possibility for being the adjustment mechanism, as an example. The spindle can consequently be rotated via the knob, and the ring element can therefore be adjusted; the ring element itself is directly connected to a screen. Alternatively there is even a possibility for an electric-motor drive to be provided that is operated from the outside, meaning via control elements on the light, and that provides for the transport of at least one screen. If multiple screens are provided, each individual screen can be moved via a gearing stage of that type so that the screens can be adjusted in an individual way vis-a-vis one another. The special advantage of this design form is, moreover, that the screens can be held in any desired position without additional latching elements. The gearing stages are preferably located above and/or below the housing elements to make even transport of the screens possible.

If the gearing stages can be moved manually or via an electric motor, the screens can consequently be rolled up or rolled out via the gearing stages. To this end, there can be further provisions for tension to simultaneously be put on a spring mechanism that supports the roll-out of the screens when the screens are rolled out.

A further design form of the invention envisages that at least one housing part has fastening means; they are intended to be used for a stand, a cable, a chain, wall-fastening means and/or ceiling-fastening means. The fastening means serve to anchor the housing parts in a fixed position so that a particular, specified area can be illuminated either outdoors or in a building, depending on the application, with the aid of the light as per the invention. The possibility exists here to arrange the light to be hanging or to be standing. The housing itself can be designed here to have the shape of a hollow cylinder, a sphere, or an ellipsoid; this design form partially refers to the housing parts and partially refers to the transparent housing element.

To increase the light intensity, there can also be provisions for at least one housing part to be provided with a reflector layer on the inside and/or for at least one housing part, preferably the lower housing part, to have a translucent design so that the scattered light that may exist can likewise be used. In particular, in the case of a light with the shape of a hollow cylinder, there are provisions for the holder for seating the screens to be designed to the effect that the reflector screen and or the diffuser screen will only engage with small areas on the edge of the housing parts and a large radiation area can consequently be achieved.

The special advantage of this invention is that with an appropriate preselection of the housing shape, whether cylindrical, spherical or ellipsoidal, a light is created that has at least one illuminant in the center that is located behind a transparent housing part so that light can be radiated. Furthermore, depending on the application, the possibility exists in the light as per the invention to push or pull a reflector screen or diffuser screen in front of the illuminant, in order to restrict the radiation angle, on the one hand, and to bring about a diffused light effect, on the other hand. The use of a reflector screen and a diffuser screen around a cylindrical housing shape is especially advantageous here; the radiation angle can be adjusted via the reflector screen over a desired range because of that, for instance 180°, 270° or 360°. The light can be guided to a specific work area in a systematic way with this measure. A diffuser screen that can preferably be spread over 360° of the light and, moreover, that has a high light intensity available to it can be used to avoid a blinding effect.

The light can be equipped with a halogen light emitter or an HQI light emitter that is arranged centrally in the light and that can be used to create a floodlight or a glare-free, diffused light with the aid of a reflector or a diffuser depending on the intended use. The special alternative of the solution that has been pointed out is, however, that an LED light tube is used as the illuminant; the outside is equipped with LEDs and the inside can be additionally equipped with cooling elements for cooling purposes. The LED light tube is mounted in the light in correspondence with the through-holes of the upper and lower housing parts here so that an air flow arises inside of the LED light tube for cooling. In addition, the possibility exists to increase the air flow with the aid of a fan.

### BRIEF DESCRIPTION OF THE DRAWINGS

The invention will be explained once again below with the aid of the figures.

FIG. 1 shows a light as per the invention in a perspective side view,

FIG. 2 shows the light known from FIG. 1 with a pulled-out reflector screen and latch at an angle of 180° in a perspective side view,

FIG. 3 shows the light known from FIG. 1 in a top view,

FIG. 4 shows a section through the light as per the invention in the axial direction with rolled-up screens,

FIG. 5 shows a section in the radial direction with rolled-up screens,

FIG. 6 shows a further section in the axial direction,

FIG. 7 shows a further embodiment of the light as per the invention with a tube-shaped through-hole with rolled-up screens in a top view,

FIG. 8 shows the light as per the invention in accordance with FIG. 7 in a sectional view in the radial direction,

FIG. 9 shows the light as per the invention in accordance with FIG. 7 with a partially pulled-out reflector screen,

FIG. 10 shows the light as per the invention with a pulled-out reflector screen in accordance with FIG. 9 in a sectional view,

FIG. 11 shows the light presented in FIGS. 7 to 10 in a sectional view in the axial direction and

FIG. 12 shows a further example of the light as per the invention in perspective in a sectional view.

### DETAILED DESCRIPTION OF THE PREFERRED EMBODIMENT

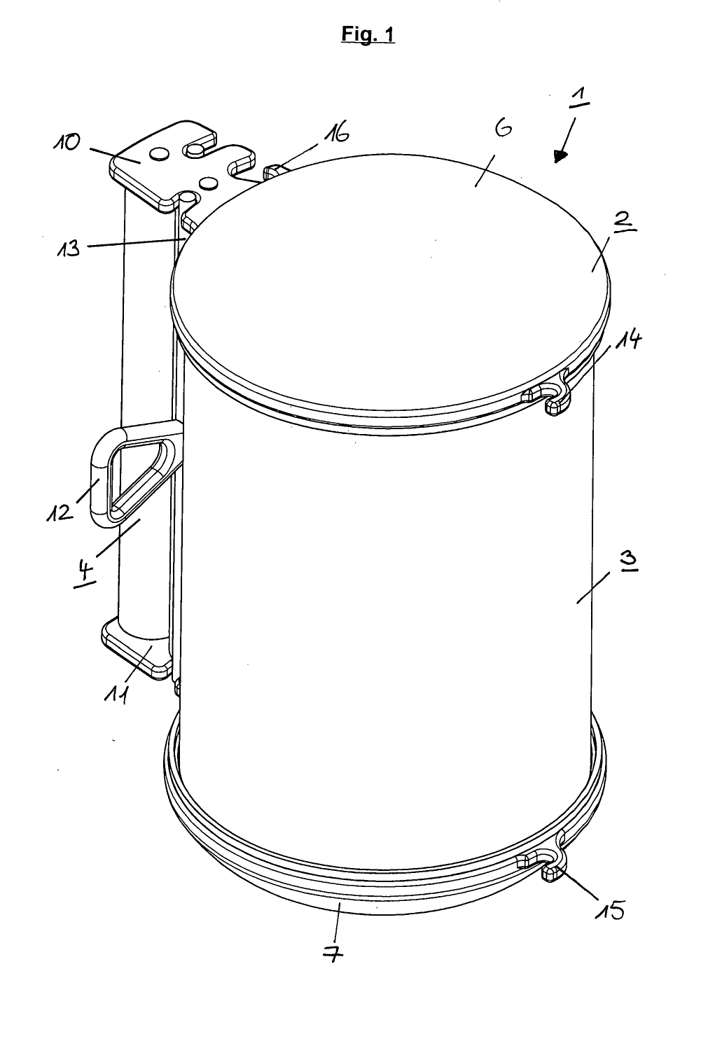

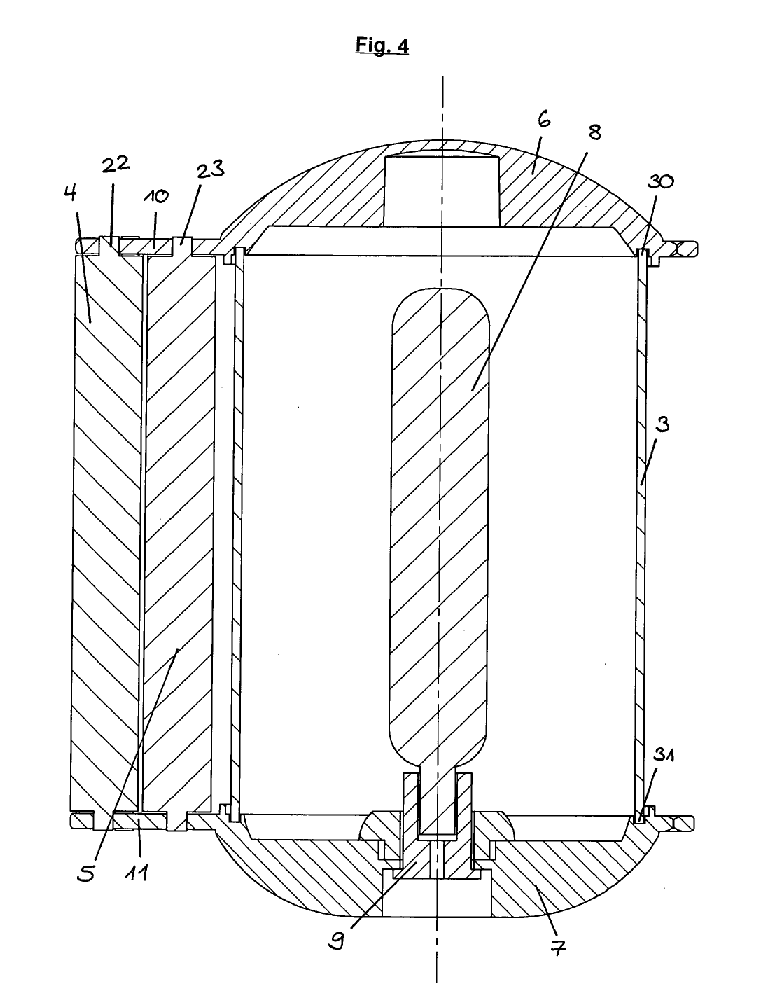

FIG. 1 shows, in a perspective side view, a light 1 as per the invention that is comprised of a housing 2 with a light-transmitting housing element 3 and two screens 4, 5 in the example that is shown; one screen 5 in this view is concealed by the light-transmitting housing element 3. The example of a light 1 that is shown is comprised in this special case of two housing parts 6, 7 that form, with a circular design, an upper and lower closure of the light 1. A light-transmitting housing element 3 that is adapted to the two housing parts 6, 7 with regard to the dimensions and that has a cylindrical shape in the example is located between the two housing parts 6, 7. An illuminant 8 that is seated in an illuminant base 9, as evident in FIG. 4, is arranged centrally vis-a-vis the housing element 3.

The upper and lower housing parts 6, 7 each have a holder 10, 11 molded in one piece. Screens 4, 5 that can be wound up in the form of a roller blind in this example and that can consequently be unwound by pulling on a handgrip 12 are arranged between the holders 10, 11. A second handgrip is concealed behind the transparent housing element 3. The screens 4, 5 can therefore by fixed in place with the aid of latching means along the circumference of the light-transmitting housing element 3. The latching means are comprised, on the one hand, of a rod 13 that can be formed in one piece with the handgrip 12, as an example; the rod 13 projects over the breadth of the screens 4, 5 and can consequently be hung in a latching position 14, 15, 16, 17 as further latching means. The latching positions 14, 15, 16, 17 can molded in one piece onto the housing parts 6, 7 over the circumference and spread out with a fairly large spacing between angles over a range of up to 360°. This measure will ensure that the screens 4, 5 can be hung in different positions to at least partially cover the light-transmitting housing element 3. The inner screen 5 could preferably be made of a translucent material here so that a scattering effect is achieved, whereas, on the other hand, the radially external screen 4 could be designed to be a reflector screen to cover certain areas of the light-transmitting housing element 3 and to consequently achieve a directional light effect. To this end, the entire light 1 will preferably be mounted so as to be capable of rotation, in addition, either in a suspended form or in the form of a standing mount, for instance on a tripod, so that the direction in which the light is to be emitted can be preselected. The latching means for the screen 4, for instance, are only provided at an angle of 180° by a latching position 14, 15 in the example that is shown. Several latching positions could be provided for the screen 4, of course, in order to likewise create a reflector effect at an angle of 270°, for instance. There is a similar situation with regard to the screen 5 that is designed to be a diffuser. Several latching steps could also be provided for it, depending on the intended use; the screen will preferably be extended over 360° of the light 1 so that all-round illumination can be effected with the aid of the diffuser screen without causing a blinding effect. Only one latching position 16 and a concealed latching position 17 of the inner housing part 7 are provided in the example. If only the outer screen 4 is used as a reflector screen, on the other hand, floodlight illumination can extend over an angle of 270° or 180°, for instance, so that there can be targeted illumination of a particular area.

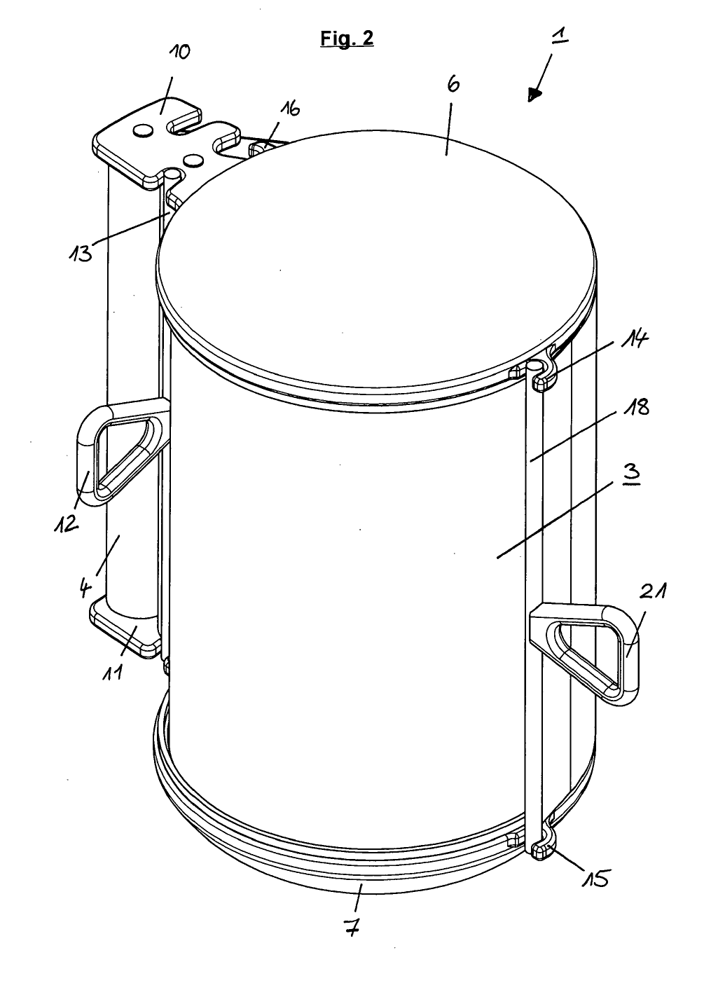

FIG. 2 shows in a perspective side view the light 1 known from FIG. 1 with its light-transmitting housing element 3 and upper and lower housing parts 6, 7. The outer screen 4, which is designed to be a reflector screen, is seated at an angle of 180° in the latching position 14, 15 in this view, so the light can be used as a floodlight with a beam angle of 180° in this position. On the other hand, the screen 5 is presented as a diffuser screen in a rolled-up position. It already becomes clear from this view that the upper housing part 6 is designed to be rounded, whereas the lower housing part 7 has a flatter shape. The light-transmitting housing element 3, which is designed to be cylindrical in the example shown and that sits with its ends in a corresponding recess of the two housing parts 6, 7, is located between the two housing parts 6, 7. The holders 10, 11, which are provided to seat the two screens 4, 5, are arranged on the side of the housing parts 6, 7. A first screen 5 is designed to be a translucent screen and has a rod 13 with a handgrip 12 so that the screen 5 can be pulled out like a roller blind and fixed in place in different positions with the aid of latching means over the circumference of the light 1. A second handgrip 21 with a rod 18 is provided for the second screen 4. The two handgrips 13, 21 serve to pull out the screens 4, 5 and to spread them over the circumference of the transparent, light-transmitting housing element. To spread the two screens 4, 5, the handgrips 13, 21 have a rod 13, 18 that extends beyond the height of the screens 4, 5 and can consequently be hung in existing latching positions 14, 15, 16, 17. The screen 5 is completely rolled up in FIG. 2, whereas the screen 4 is seated in the latching positions 14, 15 as a reflector over an angle of 180° and is therefore latched in place. The light 1 can be used as a floodlight without a diffuser effect in this position. If a diffuser effect is desired, the first screen 4 can, in addition, likewise be pulled out over a specified angle range and fixed in place with the latching means so that partial illumination with a diffuser effect can be provided by the light 1. There is the alternative possibility for the screen 5, as the reflector screen, to remain rolled up and to merely hang the screen 4, as the diffuser screen over an angle of 360°, for instance, in the specified latching position 16, 17 so that all-round illumination over 360° is achieved with a diffuser effect.

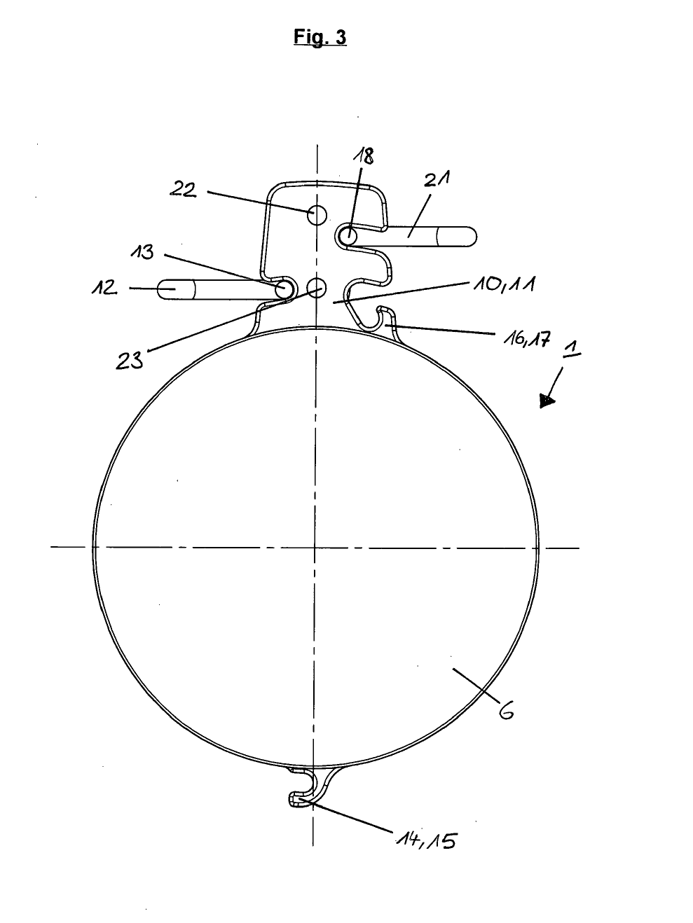

FIG. 3 shows the light known from FIG. 1 with its upper housing part 6 in a top view. The holder 10 is molded in one piece onto the housing part 6; a nearly identical holder 11 is molded onto the lower housing part 7 so that the screens 4, 5 can be spread between the two holders 10, 11. Two hinge pins 22, 23 and the two handgrips 13, 21, which make it possible to pull the screens 4, 5 out like roller blinds, are provided for this. The inner screen 4 can be pulled out with the aid of the handgrip 13 here to the effect that it can be completely spread over the circumference of the light-transmitting housing element 3; the handgrip 12 can be hung with its rod-shaped end 13 in a latching position 16, 17. The latching positions 16, 17 are located on the opposite side of the holder 10, 11 in the example that is shown. Alternatively, a possibility exist for several latching positions 14, 15, 16, 17 to be provided into which the rods 13, 21 of the first and second screens 4, 5 can be hung.

The screen 5 can likewise be pulled out of the holder 10, 11 via the handgrip 21 with the rod 18 and spread over the circumference of the light-transmitting housing element 3. A latching position 14, 15 is provided diametrically opposite to the holder 10, 11 here to spread the second screen 5 so that the screen 5 can be latched in place over an angle of 180°. There is also the alternative possibility here of providing various latching positions 14, 15 at different angle intervals so that the screen 5, which is preferably designed to be a reflector screen, can be used to select a certain angular range of the light 1 in accordance with the invention, in order to restrict the illumination field.

FIG. 4 shows an axial section of the light 1 as per the invention and, in fact, through the center point of the light 1. It is evident from this sectional view that the light-transmitting housing element 3 is arranged between the two housing parts 6, 7. The two housing parts 6, 7 have an annular groove 30, 31 that the end face of the housing element 3 rests in to fix the housing element 3 in place. It is ensured via screw connections that are also provided that the housing element 3 is securely held between the two housing parts 6, 7. The illuminant 8 that is seated in the illuminant base 9 is located in the center of the light 1. Electrical power can be supplied via a contact point in the lower area of the housing part 7. An upper holder 10 and a lower holder 11 are molded in one piece onto the tow housing parts 6, 7. The holders 10, 11 serve to seat an outer screen 4 and an inner screen 5 that can be rolled up, similar to a roller blind, and rolled out by pulling on the handgrips 12, 21, which are not visible in this sectional view. Secure seating in the holders 10, 11 is provided via a hinge pin 22, 23 here.

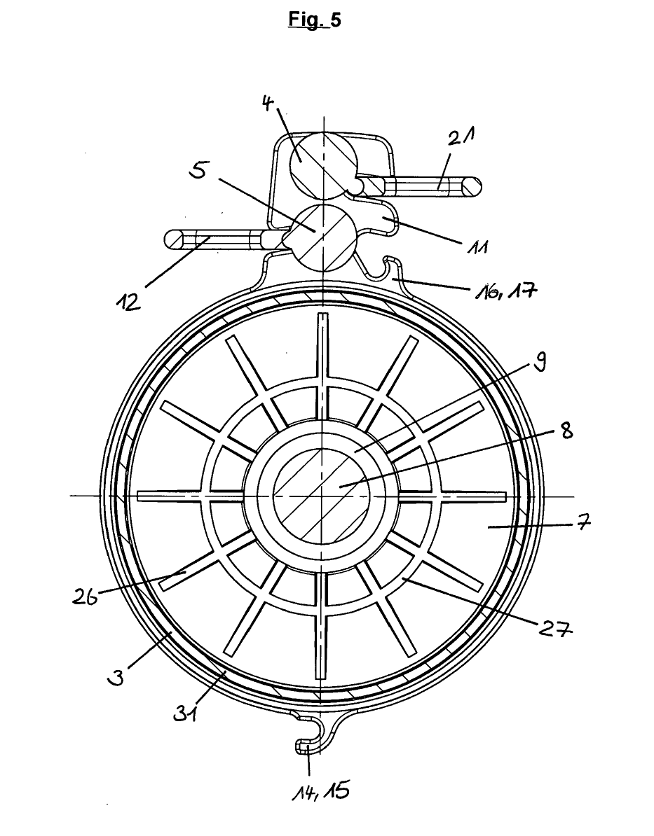

FIG. 5 shows a view of the lower housing part 7 with the illuminant 8 and the illuminant base 9 in a radial section. It is especially evident in this view that the holder 11 is connected as one piece with the lower housing part 7 and is used to seat the two screens 4, 5. The screens 4, 5 are each equipped with a handgrip 12, 21 which makes it possible for the screens 4, 5 to be pulled out, similar to a roller blind; it is possible to latch them in place in the existing latching positions 14, 15, 16, 17. It also becomes clear from this view that the lower housing part 7 and likewise the upper housing part 6 have an annular groove 31 or 30 respectively that the light-transmitting housing element 3 is seated in so that there is a lock between the two housing parts 6, 7.

The lower housing part 7 is designed to have a hollow wall for the most part here, and it has radial reinforcement struts 26 and axial reinforcement struts 27. Similar reinforcement struts are provided for the upper housing part 6.

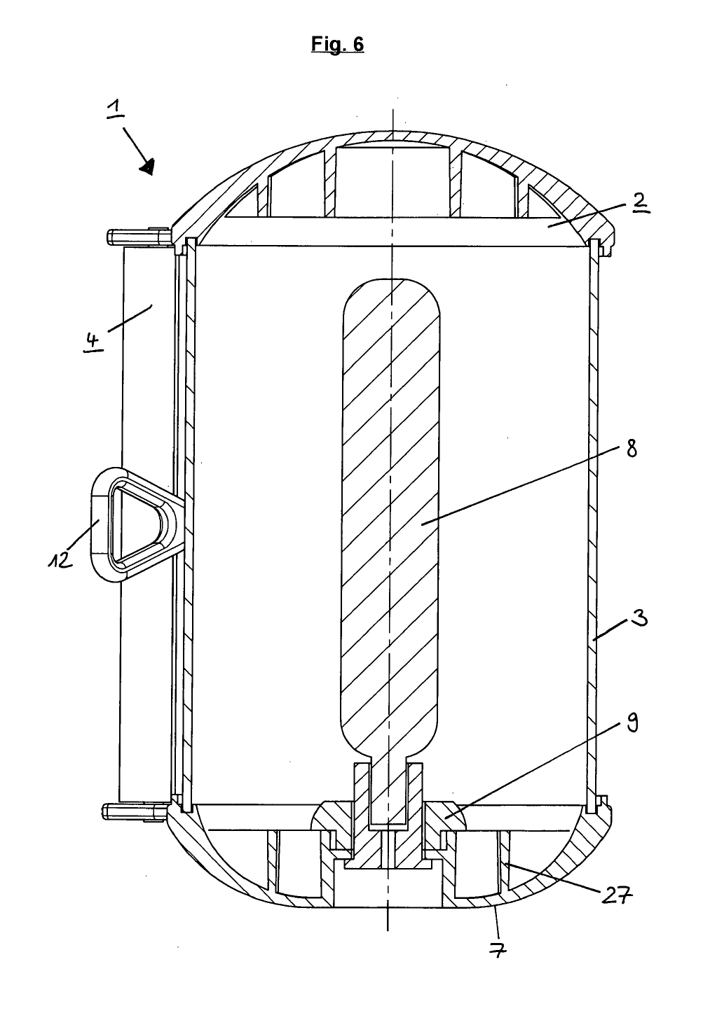

FIG. 6 shows an axial section in a further view. The figure corresponds to FIG. 4 to a very great extent; the intersection line leads off-center through the housing 2. It becomes clear from this view that the upper housing part 6 is likewise designed to have a hollow wall, and axial and radial reinforcement struts are provided.

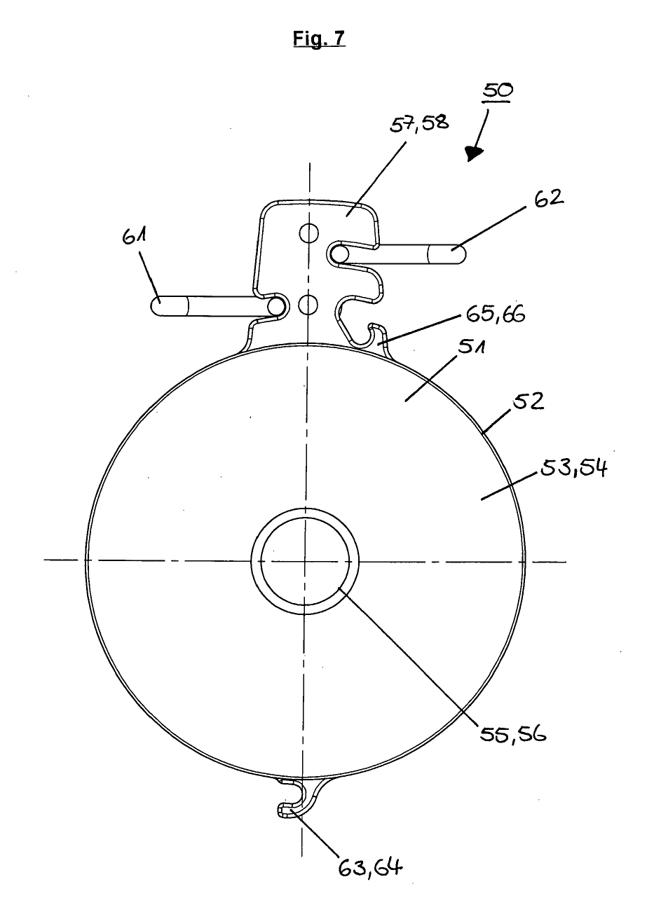

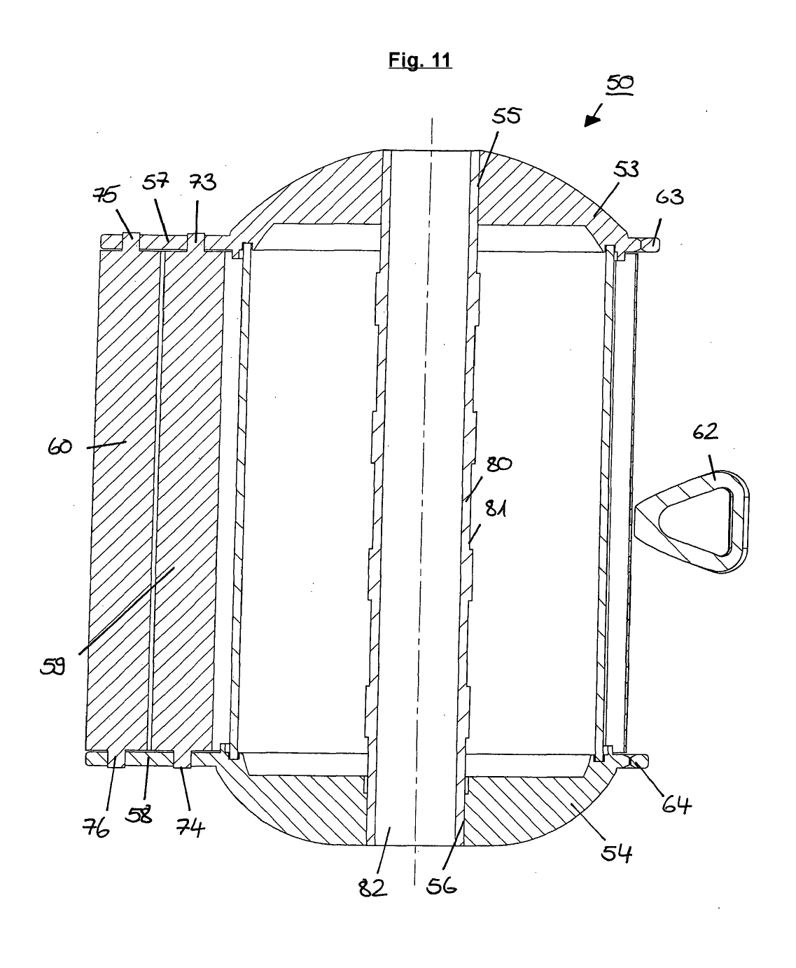

FIG. 7 shows, in a top view, a further special design form of a light 50 as per the invention with a tube-shaped through-hole. The light 50 is likewise comprised, as is especially evident form the sectional view in accordance with FIG. 11, of a housing 51 with a light-transmitting housing element 52 and upper and lower housing parts 53, 54. The structure of the light 50 corresponds to a very great extent with the light 1 described in FIGS. 1 to 6; in this example, the upper housing part 53 has a through-hole 55 and the lower housing part 54 has a through-hole 56. The two through-holes 55, 56 are flush with one another and are provided for a laminar air flow so that the interior of the light 50, especially the illuminant described in the subsequent figures, can be cooled. The two housing parts 53, 54 of the light 50 likewise have a holder 57, 58 that serves to seat two screens 59, 60. The screens 59, 60 can each be pulled out of the holder 57, 58 like a roller blind via a handgrip 61, 62 and can be spread over the circumference of the light 50 with the aid of latching means in the form of latching positions 63, 64 and 65, 66. A first screen 59 is likewise designed to be a diffuser in the light 50, whereas a second screen 60 is designed to be a reflector. A possibility consequently also exists with this light 50 to provide all-round illumination with or without a diffuser or a floodlight using the reflector. Only latching positions 63, 64 or 65, 66 are shown in the example. A possibility exists without further ado, however, to provide further latching positions on the two housing parts 53, 54.

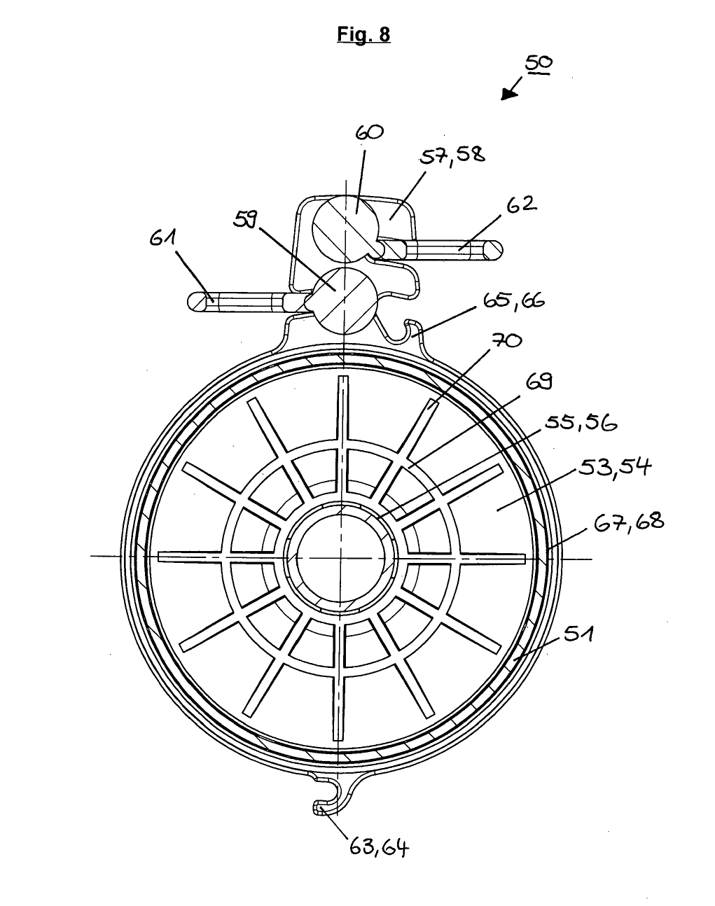

FIG. 8 shows the light 50 from FIG. 7 in a radial section; it becomes clear once again here that the two housing parts 53, 54 are provided with a through-hole 55, 56. The light-transmitting housing element 51 is comprised in the example that is shown of cylindrical Plexiglas, and it is inserted in an annular groove 67, 68 of the two housing parts 53, 54 so that a high level of stability of the overall light 50 is achieved. The view of the lower housing part 54 shows, moreover, that the housing part 54 is reinforced with a multitude of ring-shaped struts 69 and radial struts 70. The upper housing part 53 is also designed in a similar way. It is evident from this sectional view that the holders 57, 58 seat a first screen 59 and a second screen 60; the first screen 59 is designed to be a diffuser screen, and the second screen 60 is designed to be reflector screen. The two screens 59, 60 are inserted in the holders 57, 58 and can be pulled out of this holder 57, 58 like a roller blind so that latching can take place with the aid of the grips 61, 62. To this end, the handgrips 61, 62 are connected to a rod 71, 72 that can be fastened in the latching positions 63, 64 or 65, 66 so that the screens 59, 60 can be latched into place in a corresponding position, for instance 180° for the reflector screen and nearly 360° for the diffuser screen.

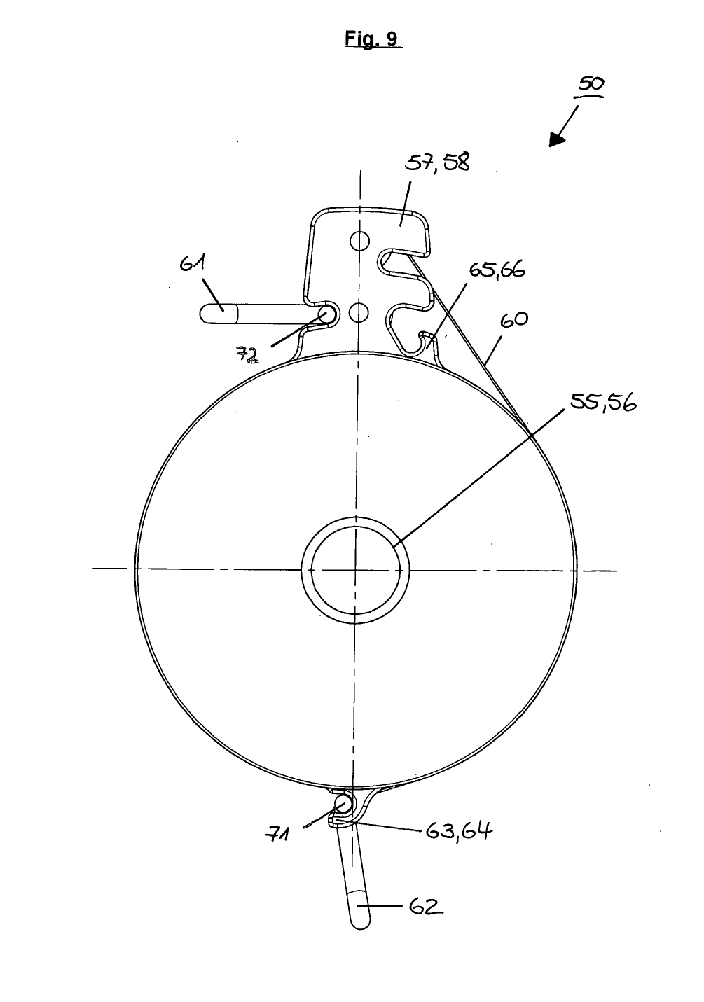

FIG. 9 shows, in a top view, the light 50 and, in fact, with a pulled-out screen 60 that has been latched into place in the latching position 63, 64 via the rod 71 with the aid of the handgrip 62. The light 50 can be used as a floodlight with a beam angle of nearly 180° in this position. The reflector screen 59 with the handgrip 61 is in a rolled-up state between the two holders 57, 58 here. It is evident from this view that the grip 61 is equipped with a rod 72 so that the diffuser, alternatively to the reflector, can be latched in place in the latching position 65, 66.

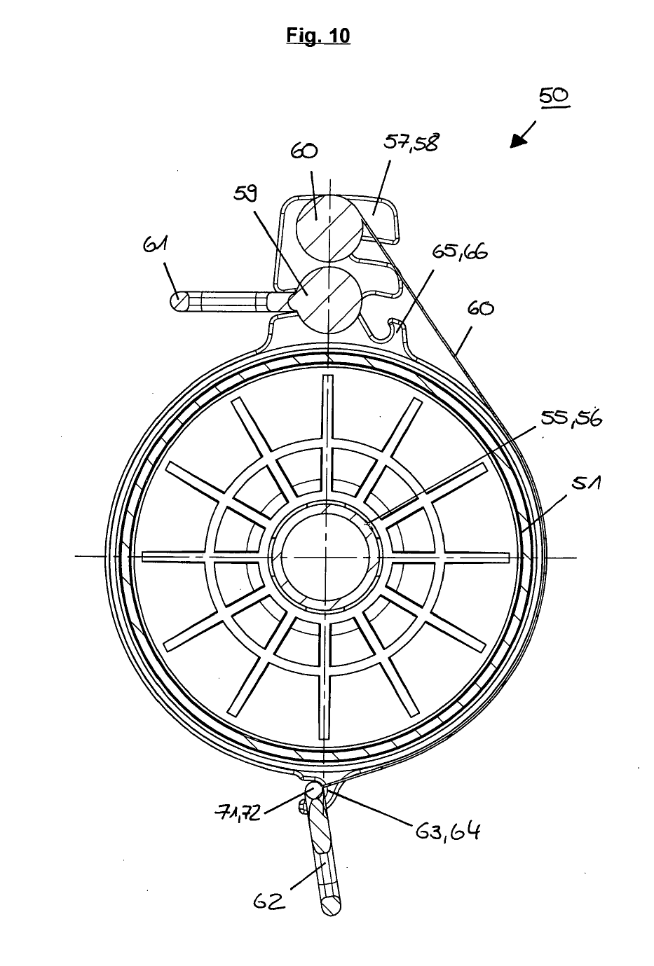

FIG. 10 once again shows, in a radial section, the light 50 as per the invention in the position known from FIG. 9; the reflector is latched in place as the second screen 60 over an angle of nearly 180° so that this light can be used as a floodlight.

FIG. 11 shows, in a sectional side view, a longitudinal section through the light 50 with an upper and lower housing part 53, 54. The holder 57, 58 is molded in one piece to the two housing parts 53, 54; the holders 57, 58 are provided to seat the first screen 59 and the second screen 60. The screens are seated in the holder 57, 58 via a stud 73, 74 or 75, 76 and can be pulled out of the holder like a roller blind with the aid of the handgrip 61, 62 so that the screen 60 can be spread as a reflector over an angle of nearly 180° with the aid of the further latching means in the form of latching positions 63, 64, whereas the first screen 59 can be latched in place as a diffuser in the latching positions 65, 66 over an angle of nearly 360°. The latching position 65, 66 is not evident in this sectional drawing, however. A through-hole 55 of the first housing part 53 and a through-hole 56 of the second housing part 54 are important in this second embodiment of the light 50. The through-holes 55, 56 correspond to one another and simultaneously serve to hold a rod-shaped illuminant 80. The light 50 as per the invention envisages the use of an illuminant 80 in the form of LEDs that are distributed around the circumference of the outer surface 81. A ventilation channel 82 that is provided to cool the LEDs on the tube-shaped wall 81 is centrally formed through the tube-shaped wall for the LEDs. The ventilation channel 82 is open at the top and bottom, so an air flow is already created by the heat development. If necessary, however, a possibility exists to additionally provide a fan, at least in the lower area, so that stronger air circulation can be achieved. Cooling of the tube-shaped wall 81 and therefore the LEDs mounted on the tube-shaped wall 81 takes place with the aid of the air circulation. This design of the light 50 ensures that adequate cooling is already provided by the air flow that arises, which can, however, additionally be reinforced with a fan if necessary.

The special advantage of the second design variant in accordance with the light 50 therefore constitutes the use of energy-saving LED illuminants; it is simultaneously ensured that adequate cooling and therefore a long service life of the individual LEDs is guaranteed.

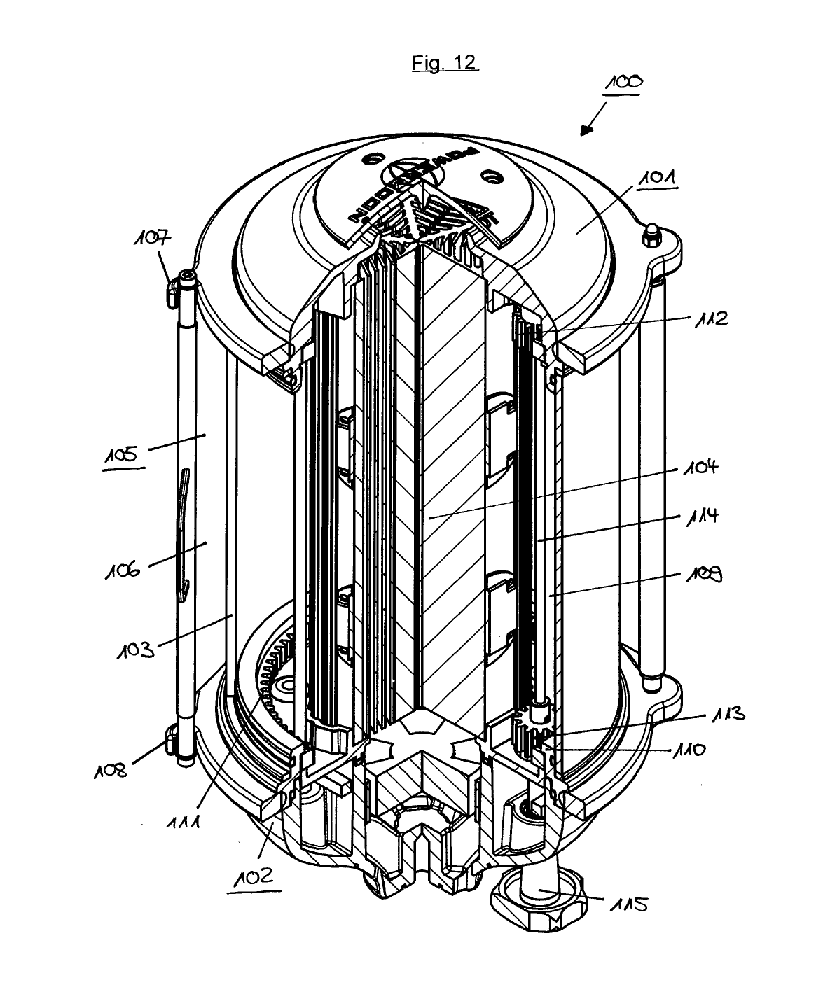

FIG. 12 shows, in a sectional view in perspective, an example of a light 100 that has an upper housing part 101 and a lower housing part 102. A housing element 103, which is designed to be transparent as in the previously described examples, is arranged between the two housing parts 101, 102. An illuminant 104 is located in the center. A screen 105 with a reflector layer 106 is located on the outside of the housing element 3. This screen 105 can be pulled out of a holder like a roller blind as in the previously described examples and hung in various latching areas 107, 108 so that a light beam can have an angle of 90 degrees, 180 degrees, 270 degrees or nearly 360 degrees, for example, when the screen is completely wound up. A second screen 109 that is connected at its end with a ring element 110 in each case is located in the light 101. The ring elements 110 have gearing 111 here that meshes with a gear ring 112, 113. The two gear rings 112, 113 are located on a spindle 114 that is routed through the lower housing part 102 and that has a knob 115; the spindle 114 is mounted so as to be capable of rotation in the lower housing part 103 and likewise in the upper housing part 101. The possibility of adjusting the inner screen 109, which is preferably designed to be a translucent screen, over 360 degrees consequently exists by actuating the knob 115.

In a further design form of the invention, there can be provisions for both screens 105 and 109 to be arranged inside of and/or outside of the housing element 103 and to be mounted so as to be capable of rotation independently of one another via two spindles 114 with gear rings 112, 113 so that both of the screens 105, 109 can be adjusted with two external knobs 115.

### LIST OF REFERENCE NUMERALS

1 Light
2 Housing
3 Housing element
4 Screen
5 Screen
6 Housing part
7 Housing part
8 Illuminant
9 Illuminant base
10 Holder
11 Holder
12 Handgrip
13 Rod
14 Latching position
15 Latching position
16 Latching position
17 Latching position
18 Rod
20 Flat area
21 Handgrip
22 Hinge pin
23 Hinge pin
26 Reinforcement strut
27 Reinforcement strut
30 Annular groove
31 Annular groove
50 Light
51 Housing
52 Housing element
53 Housing part
54 Housing part
55 Through-hole
56 Through-hole
57 Holder
58 Holder
59 Screen
60 Screen
61 Handgrip
62 Handgrip
63 Latching position
64 Latching position
65 Latching position
66 Latching position
70 Strut
71 Rod
72 Rod
73 Stud
74 Stud
75 Stud
76 Stud
80 Illuminant
81 Wall
82 Ventilation channel
100 Light
101 Housing part
102 Housing part
103 Housing element
104 Illuminant
105 Screen
106 Reflector layer
107 Latching area
108 Latching area
109 Screen
110 Ring element
111 Gearing
112 Gear ring
113 Gear ring
114 Spindle
115 Knob

1. Light comprising a housing with at least one illuminant and an illuminant holder,
characterized in that
the housing has a light-transmitting housing element that can be at least partially covered by at least one movable screen.

2. Light according to claim 1,
characterized in that
the housing element is comprised of one or more openings or
that the housing element is comprised of one or more transparent housing sections.

3. Light according to claim 1,
characterized in that
the housing has at least one upper and one lower housing part connected to one another via a light-transmitting housing element and at least one screen arranged between the two housing parts.

4. Light according to claim 1,
characterized in that
the upper and lower housing parts have a centrally located through-hole and/or that the through-hole is arranged in correspondence with the illuminant and/or that the through-hole is provided to seat a fan.

5. Light according to claim 1,
characterized in that
the housing element is comprised of a cylindrical glass or plastic cover that is seated, directly or via a guide element attached to it, in an annular groove or a corresponding guide element of the housing parts.

6. Light according to claim 1,
characterized in that
at least one screen is arranged between the two housing parts so as to be capable of reverse movement, and especially capable of being pulled out or rolled out, in the axial direction or in the direction of the circumference.

7. Light according to claim 1,
characterized in that
the housing is equipped with two screens that slide over one another or that can be moved with a spacing vis-a-vis one another, or that the housing is equipped with two screens that are arranged behind the housing element, on the one hand, and in front of the housing element, on the other hand.

8. Light according to claim 1,
characterized in that
at least one screen is designed to be a reflector or a diffuser.

9. Light according to claim 1,
characterized in that
a radially inner screen is translucent and designed to be a diffuser and a radially outer screen is designed to be a reflector, wherein it has a reflector layer on the side turned towards the illuminant.

10. Light according to claim 1,
characterized in that
the reflector is comprised of a textile material that is designed to be opaque and that has highly reflecting foil or mirror foil on the inside facing towards the illuminant and/or that the diffuser is comprised of a light-transmitting textile material or of a translucent foil, for instance a PVC foil.

11. Light according to claim 1,
characterized in that
at least one, preferably each screen, has a handgrip or a finger eyelet.

12. Light according to claim 1,
characterized in that
the housing and/or the screens have latching means, wherein they are designed to correspond to one another and the screens can be fixed in place in any desired position or in latching steps.

13. Light according to claim 1,
characterized in that
at least one, preferably two corresponding housing parts, have at least one holder for seating at least one screen, wherein the holder is designed in the form of a lateral projection.

14. Light according to claim 1,
characterized in that
the screens are mounted in the holder so as to be capable of being rotated and rolled up and can be pulled out of the holder like roller blinds and/or that at least one, preferably two screens can be moved through a gearing stage in each case via a Bowden cable, a pull chain or a pull rope and/or that a spindle is provided with an upper and lower gear ring that is supplied with a knob routed through at least one housing and the two gear rings mesh with gearing of a ring element that is connected to the inner screen, wherein the gearing stages are arranged above and/or below the housing element.

15. Light according to claim 1,
characterized in that
the gearing stages, especially the spindle, can be moved manually or with an electric motor and/or that the gearing stages can be used to roll the screens up or out.

16. Light according to claim 1,
characterized in that
the housing has fastening means, wherein they are provided for a tripod, a rope, a chain, a wall fastener and/or a ceiling fastener.

17. Light according to claim 1,
characterized in that
the housing is designed to have the shape of a hollow cylinder, a sphere, or an ellipsoid and/or that a halogen light emitter, an HQI light emitter or an LED rod unit can be used.

18. Light according to claim 1,
characterized in that
at least one housing part is supplied on the inside with a reflector layer and/or at least one housing part is designed to be translucent.
